(19) United States
(12) Patent Application Publication
(10) Pub. No.: US 2009/0202838 A1
(43) Pub. Date: Aug. 13, 2009

(54) SELF-ASSEMBLING OPTICAL FILM AND A METHOD OF MANUFACTURING THE SAME

(76) Inventors: Chun-Fa CHEN, Jhubei City (TW); Cheng-Liang Yen, Jhubei City (TW); Chi-Hua Huang, Jhubei City (TW)

Correspondence Address: RABIN & BERDO, P.C., Suite 500, 1101 14 Street, N. W., Washington, DC, 20005, US

(21) Appl. No.: 12/030,432

(22) Filed: Feb. 13, 2008

(51) Int. Cl. B32B 27/30; B32B 23/04

(52) U.S. Cl. 428/421; 428/447; 427/508

(57) ABSTRACT

A self-assembling optical film structure and a method of manufacturing the same are provided herein. The manufacturing method includes spreading a coating liquid formed with blending an acrylic resin, a fluothane-grafted acrylic resin, and a siloxane-grafted acrylic resin, or the liquid can be formed with an acrylic resin containing a fluorine compound or a silicon compound, so as to form a self-assembling optical film structure on a coated film surface, thus significantly reducing the cost. As a result, random and irregular array is generated during spreading the coating liquid, so we can effectively reduce the generation of optical interference due to the regular structure, and the product thereby has better brightness enhancement property and can be composed of relatively less layers of optical films.

### BACKGROUND OF THE INVENTION

(a) Field of Invention

The present invention relates to a self-assembling coating thin film technology applicable for brightness enhancement, glare resistance, and light diffusion. More particularly, the present invention relates to a self-assembling optical film structure with a coating surface formed by using acrylic resin and a method of manufacturing the same.

(b) Description of the Prior Art

Optical films are widely used in daily life, for example, brightness enhancement film for LCD backlight module utilizes brightness enhancement to improve the brightness of the LCD, while anti-glare film is used to shield the so-called “glare”. Accordingly, in order to make a light source to effectively enhance brightness or diffuse light, refractive index is one of main factors for high quality optical film.

When manufacturing an optical film, a photo-curing process is required for shaping. Currently, the known photo-curing process is performed by pressing with a structural wheel or adding plastic micro-particles in UV adhesive. However, the structural wheel will generate regular indentations during the process, and thus the indentation generates texture causing optical interference figure. Accordingly, in addition to viewing angle restriction, damages and defects are inevitably generated during the process. Therefore, it is necessary to combine multiple layers of films to achieve the required brightness enhancement or light diffusion effect, so that this method can reduce the defect yield and lower cost at the same time.

Therefore, the inventor of the present invention takes how to provide an optical film structure capable of alleviating the above problems and a method of manufacturing the same as the motivation for the research.

### SUMMARY OF THE INVENTION

The present invention is directed to a self-assembling optical film structure capable of alleviating the viewing angle restriction after film forming and a method of manufacturing the same.

The present invention is further directed to a self-assembling optical film structure capable of significantly reducing the cost and a method of manufacturing the same.

The present invention is further directed to a self-assembling optical film structure having better brightness enhancement property and relatively reduced number of optical films and a method of manufacturing the same.

The present invention is further directed to a low-shrinkage self-assembling optical film structure and a method of manufacturing the same, such that the substrate will not be warped after photo-curing.

As described and embodied broadly herein, the self-assembling optical film structure of the present invention mainly includes preparing a coating liquid by blending different UV curable resins with a fluothane-grafted acrylic resin, a siloxane-grafted acrylic resin, or an acrylic resin containing fluorine compound or a silicon compound, and spreading the coating liquid on a surface of a transparent substrate, so as to generate a random and irregular array.

As described and embodied broadly herein, a method of manufacturing the self-assembling optical film structure of the present invention includes: (a) providing a transparent substrate; (b) providing a coating liquid to be spread on the transparent substrate, in which the coating liquid has a fluothane-grafted acrylic resin or a siloxane-grafted acrylic resin blended therein; and (c) performing a photo-curing reaction.

The fluothane-grafted acrylic resin or the siloxane-grafted acrylic resin may be shown by the following Formula (I):

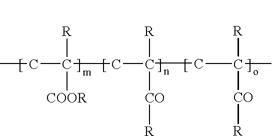

in which n, m, and o are positive integers, one R is selected from a group consisting of OC₆₋₁₂F₁₃₋₂₅ and [OZ(CH₃)₂]g, the rest five Rs are selected from a group consisting of H, OH, and C_{y}H_{2y+1}, Z is selected from a group consisting of Si, Ti, and Al, and y and g are positive integers. Additionally, two Rs may be OC₆₋₁₂X₁₃₋₂₅ and [OZ(CH₃)₂]g respectively, and the rest four Rs are selected from a group consisting of H, OH, and C_{y}H_{2y+1}.

In the method of manufacturing a self-assembling optical film structure, the photo-curing reaction is performed by using UV light or visible light having a wavelength of 210-550 nm.

In the method of manufacturing a self-assembling optical film structure, the refractive index of the coating liquid is controlled to be greater than 1.53.

Accordingly, the surface of the self-assembling optical film can have the effects of brightness enhancement or light diffusion, or can have the effects of brightness enhancement and light diffusion simultaneously. At the same time, the size of the surface structure is controlled, while the application is selectable. Compared with conventional technique, better light diffusion and brightness enhancement effects are generated, thus effectively reducing the generation of optical interference texture due to regular structure, and providing better brightness enhancement or light diffusion, thereby achieving function integration, so as to replace a dual-layer or tri-layer optical film by a single film.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a flow chart of processes of manufacturing a self-assembling optical film structure of the present invention.

FIG. 2 is a schematic view (I) of a surface structure formed by the self-assembling optical film of the present invention.

FIG. 3 shows the numerals calculated by optical simulation.

### DETAILED DESCRIPTION OF THE PREFERRED EMBODIMENTS

In order to make the examiners to understand the technical contents and efficacy of the present invention, preferable embodiments are described in detail with reference to the drawings hereinafter.

The present invention provides a self-assembling optical film structure. An acrylic resin blended with a fluothane-grafted acrylic resin, a siloxane-grafted acrylic resin, or an acrylic resin containing a fluorine compound or a silicon compound is spread with a coated film surface to form the self-assembling optical film structure.

First, a substrate is provided. The substrate is a main material for forming the optical film, generally a common transparent PET substrate, and definitely can be replaced by other transparent materials, in which the transparent PET substrate is the most common and is much cheaper.

Next, a coating liquid containing a blend of an acrylic resin with a fluothane-grafted acrylic resin, a siloxane-grafted acrylic resin, or a fluoro compound or a silicon compound is coated on the substrate, in which the coating liquid can have a curing agent and additives therein. The acrylic resin can use a coating liquid composed of acrylic functional group-containing oligomer and monomer, such as epoxy acrylate, urethane acrylate, acrylate acrylate, polyester acrylate. The monomer has a low viscosity for reducing the viscosity of the coating liquid, and thus it is unnecessary to add a solvent additionally, such as toluene, EAc, and MEK. The fluothane-grafted acrylic resin or the siloxane-grafted acrylic resin of the following chemical formula is further blended.

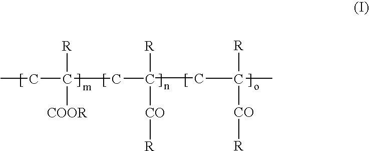

in which n, m, and o are positive integers, one R is selected from a group consisting of OC₆₋₁₂F₁₃₋₂₅ and [OZ(CH₃)₂]g, the rest five Rs are selected from a group consisting of H, OH, and C_{y}H_{2y+1}, Z is selected from a group consisting of Si, Ti, and Al, and y and g are positive integers. The blend ratio of the fluothane-grafted acrylic resin or the siloxane-grafted acrylic resin is 0.1% to 60% based on the total weight of the coating liquid. In order to effectively control the light enhancement or light diffusion property of the manufactured optical film, the blend ratio of the fluothane-grafted acrylic resin or the siloxane-grafted acrylic resin may be 0.1%-35% or 36%-60% according to the requirement.

It should be noted that, the present invention can also have a fluorine compound or a silicon compound blended therein, such as hexafluorobutyl acrylate, hexafluorobutyl methacrylate, trifluoroethyl methacrylate, dodecafluoroheptyl methacrylate, 2-(N-Ethylperfluorooctanesulfonamido)ethyl acrylate, 2-trifluoromethylacrylic acid, trifluoroethanol, hexafluorobutanol, dodecafluoro-1-heptanol, tetracosafluoroheptadecanedio. Or, the present invention can also have a polysiloxane containing a functional group of amino group, carboxyl group, epoxy group, hydroxyl group, or acrylic group blended therein.

The blend ratio of the fluorine compound or the silicon compound may be 0.1% to 60% based on the total weight of the coating liquid. In order to effectively control the light enhancement or light diffusion property of the manufactured optical film, the blend ratio of the fluothane-grafted acrylic resin or the siloxane-grafted acrylic resin may be 0.1%-35% or 36%-60% according to the requirement.

### EXAMPLES

### Example 1

Solution A was a kind of liquid mixture without any compounds having acrylate side chains and it contains 50% weight percent of bis-phenol A epoxy diacrylate and 50 weight percent of 2-Phenoxyethyl acrylate.

Solution B contains 10 weight percent of the fluothane-grafted acrylic resin or the siloxane-grafted acrylic resin has a structure of Formula (I):

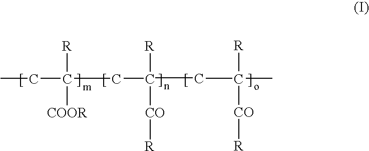

wherein n, m, and o are positive integers, one R is selected from a group consisting of OC₆₋₁₂F₁₃₋₂₅ and [OZ(CH₃)₂]g, and the rest five Rs are selected from a group consisting of H, OH, and C_{y}H_{2y+1}, Z is selected from a group consisting of Si, Ti, and Al, and y and g are positive integers.

90 weight percent of solution A was mixed with 4 weight percent synergetic agent, and then add the solution B into this mixture to achieve 100%. This liquid was blended into well mixed form as solution C.

Solution C was spread onto the transparent base materials with Slot die Coating technique.

Then, the base materials which was covered under a 25 μm-thick layer of solution C is cured under the UV with 365 nm, 800 mj/cm².

Finally, we can get light-focusing optical film with light diffusion ability of 40% haze, 85% transmittance of light.

### Example 2

Solution A was a kind of liquid mixture without any compounds having acrylate side chains and it contains 50% weight percent of bis-phenol A epoxy diacrylate and 50 weight percent of 2-Phenoxyethyl acrylate.

Solution B contains 10 weight percent of the fluothane-grafted acrylic resin or the siloxane-grafted acrylic resin has a structure of Formula (I):

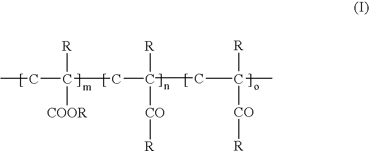

wherein n, m, and o are positive integers, one R is selected from a group consisting of OC₆₋₁₂F₁₃₋₂₅ and [OZ(CH₃)₂]g, and the rest five Rs are selected from a group consisting of H, OH, and C_{y}H_{2y+1}, Z is selected from a group consisting of Si, Ti, and Al, and y and g are positive integers.

60 weight percent of solution A was mixed with 6 weight percent synergetic agent, and then add the solution B into this mixture to achieve 100%. This liquid was blended into well mixed form as solution C.

Solution C was spread onto the transparent base materials with Slot die Coating technique.

Then, the base materials which was covered under a 25 μm-thick layer of solution C is cured under the UV with 365 nm, 800 mj/cm².

Finally, we can get light-focusing optical film with light diffusion ability of 60% haze, 85% transmittance of light.

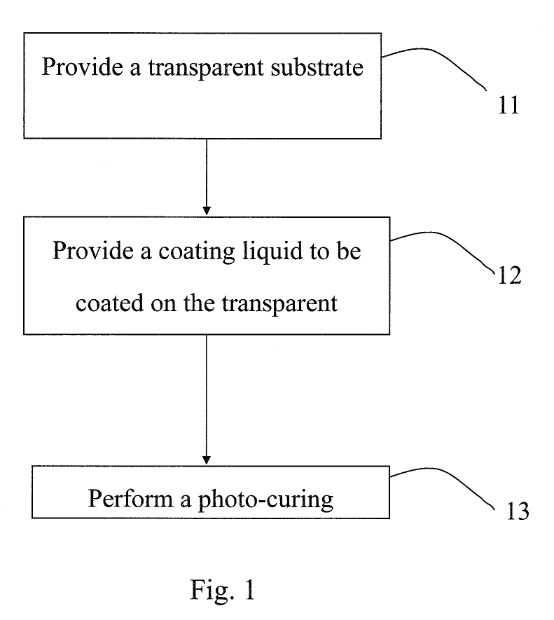

Referring to FIG. 1, a flow chart of a process of manufacturing a self-assembling optical film structure of the present invention is shown. As shown in FIG. 1, the process includes the following steps.

(a) A transparent substrate 11 is provided.

(b) A coating liquid 12 to be coated on the transparent substrate is provided. The coating liquid has a fluothane-grafted acrylic resin or a siloxane-grafted acrylic resin blended therein. Specifically, according to the present invention, first, a coating liquid having a fluothane-grafted acrylic resin or a siloxane-grafted acrylic resin blended therein is prepared. Next, the coating liquid is coated on the substrate. The coating method is, for example, slot die coating, so as to obtain high-speed and high-uniformity coating, thereby easily changing the thickness and width of the coating. Alternatively, gravure and micro gravure coating can be adopted to achieve the purpose of micro coating and have a wide application range for substrate. But the present invention is not limited to the two processes.

(c) A photo-curing reaction 13 is performed. It should be noted that, according to the present invention, the photo-curing reaction is performed by using UV light or visible light having a wavelength of 210-550 nm, so as to obtain the self-assembling optical film structure having brightness enhancement or light diffusion effect, or having brightness enhancement and light diffusion effect simultaneously. It should be noted in this step that, if the photo-curing reaction is not performed completely, residual rubber may occur. The reason may lie in high initial reaction energy (greater than 800 mj/cm²), or the wrong formulation ratio of the oligomer and the monomer, especially when the production speed is rapid (greater than 8 m/min). Therefore, the oligomer having multiple functional groups (more than three) is preferably selected, and thus lower initial reaction energy is required (lower than 800 mj/cm), thereby reducing the residual rubber.

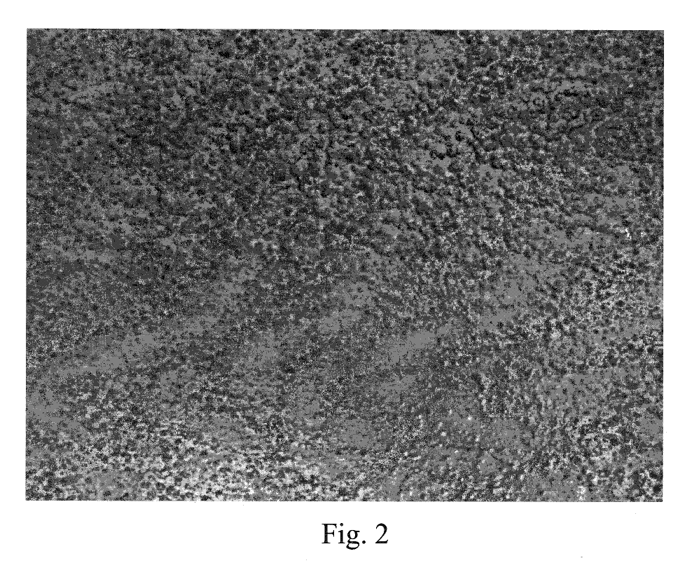

Referring to FIGS. 2, a surface structure formed by the self-assembling optical film of the present invention is shown. As shown in FIGS. 2, the self-assembling optical film structure is generated naturally, which is different from regular pattern pressed by a structural wheel. When being irradiated, the fluorine compound or the silicon compound contained in the coating liquid will protruded from the surface and form dense round protrusions. The round protrusions are irregularly and randomly distributed, thus improving the optical properties, and having brightness enhancement effect. The size of the surface structure is controlled, for example, between several μm to several tens μm, thus the optical film structure has light diffusion effect.

Further, the self-assembling optical film structure of the present invention has low shrinkage, and thus the substrate will not warped after photo-curing. Specifically, the test method is coating 25 μm of the coating liquid on a 10 cm² square substrate (PET), thus the four corners of the substrate will not warped upward or downward greater than 5 mm after photo-curing.

The substrates are made of PET, but have different thicknesses, for example, 50 μm, 100 μm, 125 μm, and 188 μm. The strictest test is performed on the substrate having a thickness of 50 μm due to the poor strength and softness of the substrate. The substrate of 188 μm will not warped, as it is harder and has a quantity of mass.

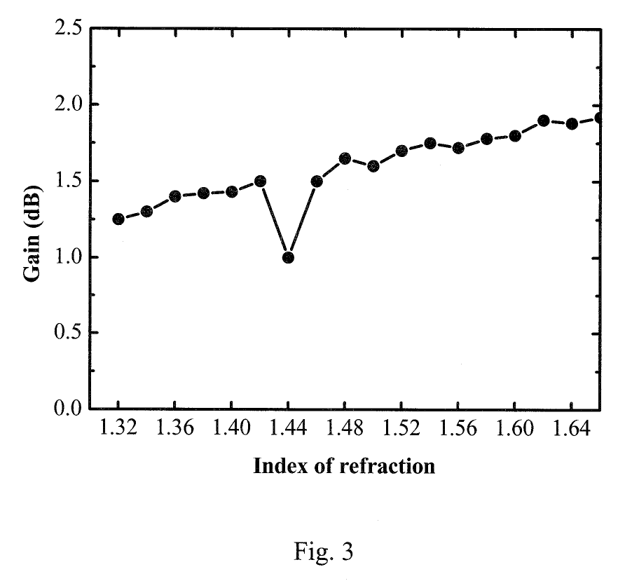

As shown in FIG. 3, it shows the numerals calculated by optical simulation. The higher the refractive index of the material is, the higher the Gain value of BEF is. Currently, the commonly used coating liquid has a refractive index of 1.54. The coating liquid prepared according to the present invention can have a refractive index varied from 1.53 to 1.57, and have a maximal refractive index of 1.57 according to the composition of the oligomer and the monomer.

In view of the above, the present invention mainly coats a coating liquid formed by blending an acrylic resin with a fluothane-grafted acrylic resin, a siloxane-grafted acrylic resin, or acrylic resin containing a fluorine compound or a silicon compound, so as to form a self-assembling optical film structure on a coated film surface, thus significantly reducing the cost. As a result, a random and irregular arrangement is generated during coating the coating liquid, thus effectively reducing the generation of optical interference texture due to the regular structure, thereby having better brightness enhancement property and relatively reducing the number of optical films.

What is claimed is:

1. A self-assembling optical film structure, comprising:
a transparent substrate; and
a coating liquid coated on the transparent substrate, having a fluothane-grafted acrylic resin or a siloxane-grafted acrylic resin of Formula (I) blended therein: 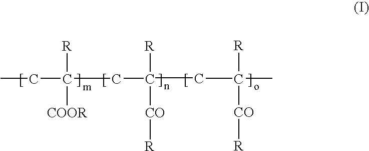
wherein n, m, and o are positive integers, one R is selected from a group consisting of OC₆₋₁₂F₁₃₋₂₅ and [OZ(CH₃)₂]g, and the rest five Rs are selected from a group consisting of H, OH, and C_{y}H_{2y+1}.

2. The optical film structure as claimed in claim 1, wherein the acrylic resin is a coating liquid composed of acrylic functional group-containing oligomer and monomer.

3. The optical film structure as claimed in claim 2, wherein the acrylic functional group is one selected from among epoxy acrylate, urethane acrylate, acrylate acrylate, polyester acrylate, or a combination thereof.

4. The optical film structure as claimed in claim 1, wherein the Z is selected from a group consisting of Si, Ti, and Al, and y and g are positive integers.

5. The optical film structure as claimed in claim 1, wherein the blend ratio of the fluothane-grafted acrylic resin or the siloxane-grafted acrylic resin is 0.1%-35% or 36%-60% based on the total weight of the coating liquid.

6. The optical film structure as claimed in claim 1, wherein the blend ratio of the fluothane-grafted acrylic resin or the siloxane-grafted acrylic resin is 36%-60% based on the total weight of the coating liquid.

7. The optical film structure as claimed in claim 1, wherein the coating liquid further has a fluorine compound or a silicon compound blended therein.

8. The optical film structure as claimed in claim 7, wherein the fluorine compound or the silicon compound is one selected from among hexafluorobutyl acrylate, hexafluorobutyl methacrylate, trifluoroethyl methacrylate, dodecafluoroheptyl methacrylate), 2-(N-Ethylperfluorooctanesulfonamido)ethyl acrylate, 2-Trifluoromethylacrylic acid, trifluoroethanol, hexafluorobutanol, dodecafluoro-1-heptanol, tetracosafluoroheptadecanediol.

9. The optical film structure as claimed in claim 7, wherein the blend ratio of the fluorine compound or the silicon compound is 0.1% to 60% based on the total weight of the coating liquid.

10. The optical film structure as claimed in claim 1, wherein the coating liquid further has polusiloxane blended therein.

11. The optical film structure as claimed in claim 10, wherein the polysiloxane contains one function group of amino group, carboxyl group, epoxy group, hydroxyl group, or acrylic group.

12. A method of manufacturing a self-assembling optical film, comprising:
(a) providing a transparent substrate;
(b) providing a coating liquid to be coated on the transparent substrate, wherein the coating liquid has a fluothane-grafted acrylic resin or a siloxane-grafted acrylic resin blended therein; and
(c) performing a photo-curing reaction.

13. The method of manufacturing a self-assembling optical film as claimed in claim 12, wherein the fluothane-grafted acrylic resin or the siloxane-grafted acrylic resin has a structure of Formula (I): 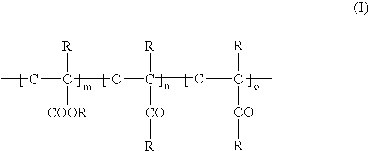
wherein n, m, and o are positive integers, one R is selected from a group consisting of OC₆₋₁₂F₁₃₋₂₅ and [OZ(CH₃)₂]g, and the rest five Rs are selected from a group consisting of H, OH, and C_{y}H_{2y+1}.

14. The method of manufacturing a self-assembling optical film as claimed in claim 12, wherein the acrylic resin is a coating liquid composed of acrylic functional group-containing oligomer and monomer.

15. The method of manufacturing a self-assembling optical film as claimed in claim 12, wherein the acrylic functional group is one selected from among epoxy acrylate, urethane acrylate, acrylate acrylate, polyester acrylate, or a combination thereof.

16. The method of manufacturing a self-assembling optical film as claimed in claim 13, wherein the Z is selected from a group consisting of Si, Ti, and Al, and y and g are positive integers.

17. The method of manufacturing a self-assembling optical film as claimed in claim 12, wherein the blend ratio of the fluothane-grafted acrylic resin or the siloxane-grafted acrylic resin is 0.1%-35% or 36%-60% based on the total weight of the coating liquid.

18. The method of manufacturing a self-assembling optical film as claimed in claim 12, wherein the blend ratio of the fluothane-grafted acrylic resin or the siloxane-grafted acrylic resin is 36%-60% based on the total weight of the coating liquid.

19. The method of manufacturing a self-assembling optical film as claimed in claim 12, wherein the coating liquid further has a fluorine compound or a silicon compound blended therein.

20. The method of manufacturing a self-assembling optical film as claimed in claim 19, wherein wherein the fluorine compound or the silicon compound is one selected from among hexafluorobutyl acrylate, hexafluorobutyl methacrylate, trifluoroethyl methacrylate, dodecafluoroheptyl methacrylate), 2-(N-Ethylperfluorooctanesulfonamido)ethyl acrylate, 2-Trifluoromethylacrylic acid, trifluoroethanol, hexafluorobutanol, dodecafluoro-1-heptanol, tetracosafluoroheptadecanediol.

21. The method of manufacturing a self-assembling optical film as claimed in claim 19, wherein the blend ratio of the fluorine compound or the silicon compound is 0.1% to 60% based on the total weight of the coating liquid.

22. The method of manufacturing a self-assembling optical film as claimed in claim 12, wherein the coating liquid further has polysiloxane blended therein.

23. The method of manufacturing a self-assembling optical film as claimed in claim 22, wherein the polysiloxane contains one functional group of amino group, carboxyl group, epoxy group, hydroxyl group, or acrylic group.

24. The method of manufacturing a self-assembling optical film as claimed in claim 12, wherein the photo-curing reaction is performed by using UV light or visible light having a wavelength of 210-550 nm.
